(19) United States
(12) Patent Application Publication
(10) Pub. No.: US 2012/0044471 A1
(43) Pub. Date: Feb. 23, 2012

(54) Lithographic Apparatus and Method

(75) Inventors: Bob Streefkerk, Tilburg (NL); Robertus Johannes Marinus De Jongh, Eindhoven (NL)

(73) Assignee: ASML Netherlands B.V., Veldhoven (NL)

(21) Appl. No.: 13/266,565

(22) PCT Filed: Mar. 18, 2010
(86) PCT No.: PCT/EP2010/053506

§ 371 Date: Oct. 27, 2011

Related U.S. Application Data
(60) Provisional application No. 61/172,886, filed on Apr. 27, 2009.

(51) Int. Cl. G03B 27/42

(52) U.S. Cl. 355/53; 355/77

(57) ABSTRACT

A method of projecting a patterned beam onto a substrate using an EUV lithographic apparatus having a projection system including a plurality of mirrors. The method includes the following steps. Using the projection system to project the patterned beam onto the substrate while moving a final mirror of the projection system in a direction substantially perpendicular to the surface of the substrate. Rotating the final mirror to substantially compensate for unwanted translation of the projected patterned radiation beam on the substrate due to the movement of the mirror.

### BACKGROUND

1. Field of the Invention

The present invention relates to a lithographic apparatus and method.

2. Background Art

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g., comprising part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned. Imaging of the pattern onto the substrate is performed by a projection system, which may comprise a plurality of lenses or mirrors.

Lithography is widely recognized as one of the key steps in the manufacture of ICs and other devices and/or structures. However, as the dimensions of features made using lithography become smaller, lithography is becoming a more critical factor for enabling miniature IC or other devices and/or structures to be manufactured.

A theoretical estimate of the limits of pattern printing can be given by the Rayleigh criterion for resolution as shown in equation (1):

CD=k₁λ/NA_{PS} (1)

where λ is the wavelength of the radiation used, NA_{PS} is the numerical aperture of the projection system used to print the pattern, k1 is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength λ, by increasing the numerical aperture NA_{PS} or by decreasing the value of k1.

In order to shorten the exposure wavelength and, thus, reduce the minimum printable size, it has been proposed to use an extreme ultraviolet (EUV) radiation source in a lithographic apparatus. EUV radiation sources are configured to output a radiation wavelength of around 13.5 nm. Thus, EUV radiation sources may constitute a significant step toward achieving printing of small features.

The focus depth which is provided by the projection system of an EUV lithographic apparatus may be relatively small. Furthermore, the focus depth decreases as the numerical aperture of the projection system increases (the depth of focus is proportional to 1/(NA_{PS})2.

### SUMMARY

It is desirable to provide an EUV lithographic apparatus and method which is capable of providing a greater effective focus depth.

According to an embodiment of the present invention, there is provided a method of projecting a patterned radiation beam onto a substrate using an EUV lithographic apparatus having a projection system comprising a plurality of mirrors comprising the following steps. Using the projection system to project the patterned radiation beam onto the substrate while moving a final mirror of the projection system in a direction substantially perpendicular to the surface of the substrate. Rotating the final mirror to substantially compensate for unwanted translation of the projected patterned radiation beam on the substrate due to the movement of the mirror.

According to another embodiment of the present invention. there is provided an EUV lithographic apparatus comprising a projection system having a plurality of mirrors and a substrate table configured to support a substrate. A final mirror of the projection system is arranged to direct a patterned radiation beam onto the substrate. The apparatus further comprises an actuator configured to move the final mirror of the projection system in a direction substantially perpendicular to the surface of the substrate and configured to rotate the final mirror in a manner which will substantially compensate for unwanted translation of the projected patterned radiation beam on the substrate due to the movement of the mirror.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 schematically depicts a lithographic apparatus, according to an embodiment of the invention.

FIG. 2 is a more detailed schematic illustration of the lithographic apparatus of FIG. 1.

FIG. 3 schematically depicts an exposure area that is illuminated by a lithographic apparatus, according to an embodiment of the present invention.

FIG. 4 schematically depicts movement of a mirror of a lithographic apparatus, according to an embodiment of the present invention.

FIG. 5 schematically depicts a control system of a lithographic apparatus, according to an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

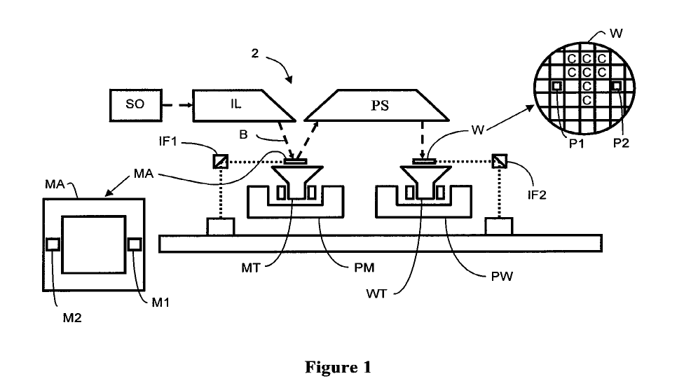

FIG. 1 schematically depicts a lithographic apparatus 2 which embodies the invention. The apparatus 2 comprises an illumination system (illuminator) IL configured to condition a radiation beam B (e.g., extreme ultraviolet (EUV) radiation); a support structure (e.g., a mask table) MT constructed to support a patterning device (e.g., a mask) MA and connected to a first positioner PM configured to accurately position the patterning device in accordance with certain parameters; a substrate table (e.g., a wafer table) WT constructed to hold a substrate (e.g., a resist coated wafer) W and connected to a second positioner PW configured to accurately position the substrate in accordance with certain parameters; and a projection system (e.g., a reflective projection lens system) PS configured to project a pattern imparted to the radiation beam B by patterning device MA onto a target portion C (e.g., comprising one or more dies) of the substrate W.

The illumination system may include various types of optical components, such as refractive, reflective, magnetic, electromagnetic, electrostatic or other types of optical components, or any combination thereof, for directing, shaping, or controlling radiation. In most EUV lithographic apparatus, the illumination system is predominantly formed from reflective optical components.

The support structure supports, i.e., bears the weight of, the patterning device. It holds the patterning device in a manner that depends on the orientation of the patterning device, the design of the lithographic apparatus 2, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

Examples of patterning devices include masks and programmable mirror arrays. Masks are well known in lithography, and typically, in an EUV radiation lithographic apparatus, would be reflective. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

As here depicted, the apparatus 2 is of a reflective type (e.g., employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation emission point by means of the collector assembly/radiation source SO. The source and the lithographic apparatus may be separate entities. In such cases, the collector assembly is not considered to form part of the lithographic apparatus and the radiation beam is passed from the collector assembly SO to the illuminator IL with the aid of a beam delivery system comprising, for example, suitable directing mirrors and/or a beam expander. In other cases the source may be an integral part of the lithographic apparatus. The collector assembly SO including the radiation generator and the illuminator IL, together with the beam delivery system if required, may be referred to as a radiation system.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator and a condenser. The illuminator IL may be used to condition the radiation beam B to have a desired uniformity and intensity distribution in its cross-section.

The radiation beam B is incident on the patterning device (e.g., mask MA), which is held on the support structure (e.g., mask table MT), and is patterned by the patterning device. Having been reflected by the mask MA, the radiation beam B passes through the projection system PS, which focuses the beam onto a target portion C of the substrate W. With the aid of the second positioner PW, and position sensor IF2 (e.g., an interferometric device, linear encoder or capacitive sensor), the substrate table WT can be moved accurately, e.g., so as to position different target portions C in the path of the radiation beam B. Similarly, the first positioner PM and another position sensor IF1 can be used to accurately position the mask MA with respect to the path of the radiation beam B, e.g., after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

A detector D according to an embodiment of the invention, is provided in the substrate table WT. The detector is described further below.

The depicted apparatus 2 could be used in at least one of the following modes:

1. In step mode, the mask table MT and the substrate table WT are kept essentially stationary, while an entire pattern imparted to the radiation beam is projected onto a target portion C at one time (i.e., a single static exposure). The substrate table WT is then shifted in the plane of the substrate so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e., a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

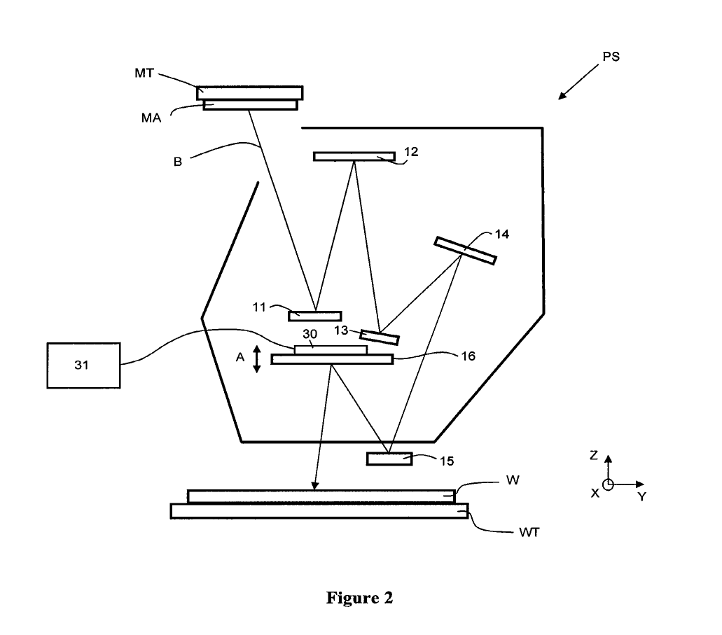

FIG. 2 shows the projection system PS in more detail, according to one embodiment of the present invention. The projection system PS comprises six mirrors 11-16, which are arranged to project a beam of patterned radiation B from the patterning device MA onto the substrate W.

Cartesian coordinates are indicated in FIG. 2 (and in subsequent figures). For ease of understanding, the z-direction may be considered to be vertically upwards, with the x and y directions being horizontal. However, the Cartesian coordinates are not limited to this, and may be oriented in any suitable direction.

In this example, a first mirror 11 of the projection system PS receives the radiation beam B, and is arranged to direct the radiation beam diagonally upwards to a second mirror 12 of the projection system. The second mirror 12 is arranged to direct the radiation beam B diagonally downwards to a third mirror 13, which is located adjacent to the second mirror 12. The third mirror 13 is arranged to direct the radiation beam B diagonally upwards to a fourth mirror 14. The fourth mirror 14 is arranged to direct the radiation beam B diagonally downwards towards a fifth mirror 15. The fifth mirror 15 is arranged to direct the radiation beam B diagonally upwards towards the sixth mirror 16. The sixth mirror is arranged to direct the radiation beam onto the substrate W.

In one example, one or more of the mirrors 11-16 may be curved. For example, the sixth mirror 16 may be concave. The radius of curvature of the sixth mirror 16 may be proportional to the numerical aperture of the projection system PS, and/or to the distance between the sixth mirror and the substrate W. The diameter of the sixth mirror 16 may be linked to the distance between the sixth mirror and the substrate W (a larger distance giving rise to a larger diameter).

In this example, the combined effect of the mirrors 11-16 of the projection system PS is to form an image of the patterning device MA on the substrate W. It may be that the image formed on the substrate W does not precisely correspond with the pattern on the patterning device MA. For example, the patterning device MA may include so called assist features, which help to form pattern features on the substrate W, and which are not themselves seen on the substrate.

In an embodiment, the sixth mirror 16 is configured such that it may be actuated in the z-direction during projection of a pattern onto the substrate W. Movement of the sixth mirror 16 is indicated by double-headed arrow A. Moving the sixth mirror 16 in the z-direction during projection of a pattern onto the substrate W increases the effective depth of focus of the projection system PS.

It is known to increase the depth of focus of the projection system of a conventional (non-EUV) lithographic apparatus by tilting the substrate table (the tilt being around an axis which is transverse to a scanning direction of the substrate table). This tilt has the effect of causing exposure radiation to be incident upon the substrate at a variety of positions in the z-direction, thereby providing an increase of effective focus depth. Tilting the substrate table in this way does not significantly reduce the accuracy with which the pattern is formed on the substrate. This is because the shape of an exposure area illuminated by the lithographic apparatus is symmetric with respect to the axis of the tilt (the term ‘exposure area’ refers to the area of the substrate that is illuminated by the beam of radiation).

Referring to FIG. 2, the scanning direction of the substrate table WT of the EUV lithographic apparatus of the embodiment of the invention may be the y-direction. The exposure area may have a shape which is not symmetric about an axis which extends in the x-direction. As a consequence of this lack of symmetry, tilting of the substrate table WT would significantly reduce the accuracy with which the pattern is projected onto the substrate W. The embodiment of the invention solves this problem by increasing the focus depth of the projection system PS using an entirely different approach (i.e., via movement in the z-direction of the sixth mirror 16).

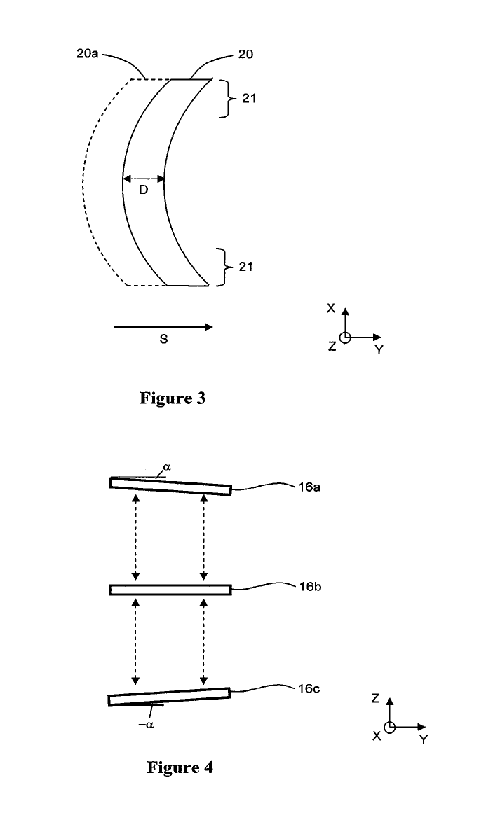

FIG. 3 shows schematically one example of an exposure area 20 of the projection system PS, according to an embodiment of the present invention. In this example, the exposure area 20 has a curved shape. It can be seen from FIG. 3 that the exposure area 20 is not symmetric about an axis which extends in the x-direction. The width of the exposure area 20 is indicated as D.

In one example, during operation of the lithographic apparatus, the substrate table WT (see FIG. 2) is moved in a scanning motion in the y-direction (the term “scanning motion” is intended to mean motion at a steady speed). This is indicated by arrow S in FIG. 3. As a consequence of this scanning motion, the exposure area 20 moves over the surface of the substrate. For example, the exposure area may move by distance D relative to the substrate, as represented by the displaced exposure area 20a.

In one example, the sixth mirror 16 may be configured such that it travels through a cycle of movement in the z-direction during the time taken for the substrate W to move by distance D (i.e., to move by a distance which is equal to the width of the exposure area 20). The term ‘cycle of movement’ is intended to mean that the sixth mirror 16 moves from a starting point, through a range of positions in the z-direction, and back to the starting point.

The sixth mirror 16 may be configured such that it travels through a plurality of cycles of movement in the z-direction during the time taken for the substrate W to move by distance D. The number of cycles may for example be 2 cycles, 6 cycles, 12 cycles, or any other suitable number.

In one example, the z-position of the sixth mirror 16 may follow a sinusoidal profile. Movement of the sixth mirror may begin at a z-position which is at the top or bottom of the cycle of movement. This may avoid the need to instantaneously accelerate the sixth mirror 16 to a particular velocity (the starting velocity of the mirror at the top or bottom of cycle of movement is zero).

In one example, movement of the sixth mirror 16 in the z-direction may give rise to unwanted translation in the y-direction of the image projected onto the substrate W (arising from y-direction translation of the exposure area). For example, actuation of the sixth mirror 16 by about 100 nm in the z-direction may give rise to an unwanted translation in the y-direction of the image by about 14 nm. In order to eliminate (or significantly reduce) unwanted y-direction translation of the image, the sixth mirror 16 may configured to undergo some rotation at the same time as moving in the z-direction. The rotation may be around an axis which extends in the x-direction. The rotation may be arranged to substantially compensate for the unwanted y-direction translation of the image, such that there is no net y-direction translation of the image (or a significantly reduced amount of y-direction translation of the image). The rotation and the z-direction movement may be coupled. This may be expressed as Ry=Az, where Ry is rotation of the sixth mirror, around the x-axis and relative to the y-axis, z is the z-direction displacement of the sixth mirror relative to an intermediate position, and A is a constant.

FIG. 4 shows schematically movement of the sixth mirror 16 in the z-direction, together with tilting of the sixth mirror around an axis which extends in the x-direction, according to one embodiment of the present invention. In this example, the sixth mirror starts at an initial position 16a, which is at the top of the sixth mirror's cycle of movement. The sixth mirror is tilted at an angle α relative to the y-axis. The sixth mirror moves down through an intermediate position 16b to a bottom position 16c, which is at the bottom of the sixth mirror's cycle of movement. At the intermediate position 16b, the tilt angle of the sixth mirror is zero (i.e., there is no tilt relative to the y-axis). At the bottom position 16c, the sixth mirror is tilted at an angle −α relative to the y-axis.

The mirror returns to the top position 16a, thereby completing a cycle of movement in the z-direction, and completing a cycle of tilt orientations. The term ‘cycle of tilt orientations’ is intended to mean that the sixth mirror 16 moves from a starting orientation, through a range of tilts, and back to the starting orientation.

In one example, the sixth mirror 16 may be configured such that it passes through a cycle of tilt orientations during the time taken for the substrate W to move by distance D (i.e., to move by a distance which is equal to the width of the exposure area 20). The sixth mirror 16 may be configured such that it travels through a plurality of cycles of tilt orientation during the time taken for the substrate W to move by distance D. The number of cycles may for example be 12 cycles, or any other suitable number.

Referring again to FIG. 3, some unwanted magnification of the image may occur at outer portions 21 of the exposure area 20 due to the movement of the sixth mirror 16 in the z-direction. For example, there may be a magnification error of the magnification along the x-axis which leads to the unwanted magnification of the image. The magnification error may be proportional to the z-movement of the sixth mirror 16. An effect of such unwanted magnification is a fading along the x-direction of a pattern image during exposure. A resulting contrast loss may in turn lead to a critical dimension error of the printed features. Such an effect of this unwanted magnification may be compensated for by adjusting the intensity of radiation which is delivered to the exposure area 20. For example, the intensity of radiation in the outer portions 21 of the exposure area may be greater than the intensity of radiation at the centre of the exposure area. This increase of the intensity of radiation counteracts the effect of unwanted magnification (e.g., reducing the critical dimension at outer portions 21 of the exposure area).

In one example, the intensity of radiation delivered to the exposure area 21 may be adjusted by introducing opaque fingers into the radiation beam, thereby reducing the intensity of the radiation beam at specific spatial locations. The opaque fingers may for example be located outside of the projection system PS, close to the patterning device MA. In an embodiment, in order to provide outer portions 21 of the exposure area 20 with radiation having a higher intensity than other parts of the exposure area, the intensity of radiation in those other parts of the exposure area is reduced using the opaque fingers.

In one example, the sixth mirror 16 may for example be actuated through a about 200 nm range of movement (for example about 100 nm either side of a central position). The tilt of the sixth mirror may be sufficient to compensate for translation of the image in the y-direction by around 15 nm per 100 nm of z-direction movement of the sixth mirror (e.g., by around 30 nm in total). The tilt of the sixth mirror may for example be around 10 nrad per 100 nm z-direction movement (e.g., by about 10 nrad either side of a central position).

The scan speed of the substrate table WT may for example be about 250 mm/s, and the width D of the exposure area 20 may for example be about 1.4 mm. The time taken for the substrate table WT to move distance D would thus be about 5.6 ms. A cycle of movement of the sixth mirror 16 in the z-direction, and a corresponding cycle of tilt, may take place in about 5.6 ms. This corresponds with a frequency of about 178 Hz.

In one example, the position and orientation of the sixth mirror 16 may be adjusted by an actuator 30, which may be controlled by a control system 31. The control system 31 may comprise low frequency components and high frequency components. The low frequency components may be used for example to move the sixth mirror 16 in a manner which corrects for a slowly varying optical property of the projection system PS. The high frequency components may be used to move the sixth mirror 16 in the z-direction, and rotate it about an x-axis, in the manner described above.

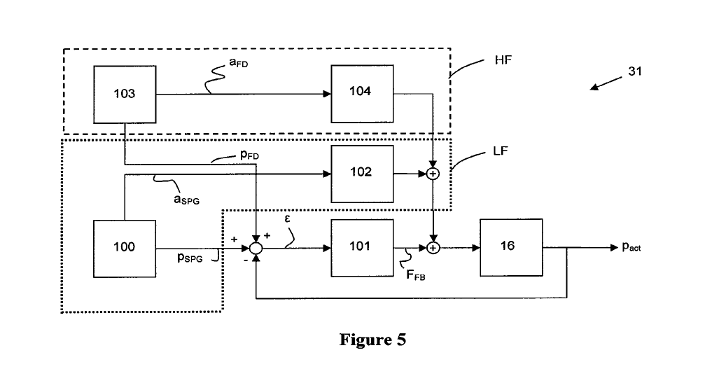

FIG. 5 show an example of a control system 31, according to an embodiment of the present invention. The low frequency components of the control system 31 are surrounded by a dotted line LF, and the high frequency components are surrounded by a dashed line HF.

In this example, the low frequency components comprise a first setpoint generator 100 and a first feed-forward controller 102. The high frequency components HF comprise a second setpoint generator 103 and a second feed-forward controller 104. Both setpoint generators 100, 103 provide input to a feedback controller 101, which is connected to the sixth mirror 16.

In this example, in use, the combined position outputs pSPG, pFD of the first and second setpoint generators 101, 103 are compared with the actual position pact of the sixth mirror 16, and the differences is passed to the feedback controller 101. The feedback controller 101 generates an output FFB which is used to adjust the position of the sixth mirror 16 accordingly.

In one example, the acceleration profile output aSPG of the first setpoint generator 100 is used by the first feed-forward controller 102 to generate a position adjustment output. The acceleration profile output aFD of the second setpoint generator 103 is used by the second feed-forward controller 104 to generate an additional position adjustment output. These outputs are combined and added to the output from the feedback controller 101, to provide a combined output which adjusts the position of the sixth mirror 16.

In an embodiment, the sixth mirror has an at-rest central position (position 16b in FIG. 4). The first setpoint generator 100 and feed-forward controller 102 provide output signals which move the sixth mirror to for example about 100 nm above the central position (position 16a in FIG. 4). This position 16a is the initial position of the sixth mirror 16. The second setpoint generator 103 and feed-forward controller 104 output signals which move the sixth mirror to about 200 nm below the central position (position 16c in FIG. 4), and back to the initial position, etc with a frequency of for example 178 Hz. The second setpoint generator 103 and feed-forward controller 104 also cause the sixth mirror to tilt through a desired angle relative to the x-axis at a corresponding frequency.

In one example, the sixth mirror is moved to the initial position 16a before exposure of a target portion C (see FIG. 1) of the substrate W begins. Movement of the sixth mirror through the cycle of positions shown in FIG. 4 begins when exposure of the target portion of the substrate begins.

In one example, the high frequency components 103, 104 may be arranged to operate at particular frequency. The frequency may for example provide one or more cycles of movement during the time taken for the substrate table WT to move a distance which corresponds to the width of the exposure area 20 (see FIG. 3). Operating the high frequency components 103, 104 at a particular frequency may provide the advantage that it is possible to determine cross-talk of the movement into other degrees of freedom of the sixth mirror, and to compensate for this (cross-talk may arise from the finite mass of the sixth mirror).

The frequency of operation of the high frequency system HF may vary. For example, it may be different for projection of different patterns onto substrates. For example, when projecting a first pattern, a first scan speed of the substrate table WT may be used, and when projecting a second pattern, a second different scan speed of the substrate table WT may be used. Similarly, the width of the exposure area 20 may be different when projecting the first and second patterns. The frequency of operation of the high frequency components 103, 104 may be adjusted such that movement and tilting of the sixth mirror occurs in cycles which correspond to a substrate movement equal to the width of the exposure area. If the frequency of operation of the high frequency system is changed, then the compensation of cross-talk may also be modified accordingly.

In the above description, the movement of the sixth mirror 16 has been described as being in the z-direction. The term “z-direction” may be understood as meaning a direction which is substantially perpendicular to the surface of the substrate W.

In the above description, the rotation of the sixth mirror 16 has been described as being around the x-axis. The term “x-axis” may be understood as meaning an axis which is substantially perpendicular to the direction of scanning motion of the substrate table WT.

Although it may be possible to increase the effective focus depth provided by the projection system PS by moving one of the other mirrors 11-15, movement of one or more of those mirrors could give rise to substantial distortion or substantial unwanted translation of the image projected onto the substrate. In an embodiment, movement of the sixth mirror 16 is therefore preferred.

The above described embodiment of the invention relates to a projection system which comprises six mirrors 11-16. However, the projection system may comprise any other suitable number of mirrors. For example, the projection system may comprise 4 or more mirrors. The projection system may comprise 8 or less mirrors. In each case, it is the final mirror of the plurality of mirrors (i.e., the mirror which directs the pattern onto the substrate), which is moved in the z-direction and is rotated.

The above described embodiment of the invention relates to a lithographic apparatus which operates in scan mode (the mask table MT and the substrate table WT are scanned synchronously while a pattern imparted to the radiation beam is projected onto a target portion C). However, embodiments of the present invention may also be used in a lithographic apparatus which operates in step mode (the mask table MT and the substrate table WT are kept essentially stationary, while an entire pattern imparted to the radiation beam is projected onto a target portion C at one time). Where this is the case, the lithographic apparatus may have a projection system PS which is similar to that shown in FIG. 2. The sixth mirror 16 may move in the z-direction, and may rotate around an axis which extends in the x-direction (in order to compensate for unwanted translation in the y-direction of the image projected onto the substrate W). The rotation of the sixth mirror may be synchronized with the z-direction movement of the sixth mirror. The sixth mirror 16 may be configured such that it travels through a plurality of cycles of movement in the z-direction during the time taken for the target portion C to be exposed. Similarly, the sixth mirror 16 may be configured such that it travels through a plurality of cycles of rotation during the time taken for the target portion C to be exposed. The number of cycles may for example be 2 cycles, 6 cycles, 12 cycles, or any other suitable number.

In the above description, the term EUV is intended to refer to extreme ultraviolet radiation. Although extreme ultraviolet radiation in a lithographic apparatus is often centered around 13.5 nm, the term extreme ultraviolet radiation may encompass other wavelengths (e.g., wavelengths in the range 5-20 nm).

Although specific reference may be made in this text to the use of lithographic apparatus in the manufacture of integrated circuits, it should be understood that the lithographic apparatus described herein may have other applications, such as the manufacture of integrated optical systems, guidance and detection patterns for magnetic domain memories, flat-panel displays, liquid-crystal displays (LCDs), thin film magnetic heads, etc.

The descriptions above are intended to be illustrative, not limiting. It will be apparent to one skilled in the art that the invention is also represented by the clauses set out below.

1. A method of projecting a patterned radiation beam onto a substrate using an EUV lithographic apparatus having a projection system comprising a plurality of mirrors, the method comprising:

using the projection system to project the patterned radiation beam onto the substrate whilst moving a final mirror of the projection system in a direction substantially perpendicular to the surface of the substrate, and rotating the final mirror to substantially compensate for unwanted translation of the projected patterned radiation beam on the substrate due to the movement of the mirror.

2. The method of clause 1, wherein the rotation of the final mirror is synchronized with the movement of the final mirror.

3. The method of clause 1 or 2, wherein the lithographic apparatus is a scanning apparatus which moves the substrate relative to the projection system in a scanning movement, and the rotation of the final mirror is around an axis which is substantially perpendicular to the direction of scanning movement of the substrate.

4. The method of any of the clauses 1-3, wherein an intensity of radiation at outer portions of an exposure area is greater than an intensity of radiation at other portions of the exposure area.

5. The method of clause 3, wherein the speed of the scanning movement of the substrate is such that during a period of time T the substrate moves a distance which corresponds with the width of an exposure area defined by the patterned radiation beam, and wherein during the period of time T the final mirror moves through one or more cycles of movement from an initial position, to positions which are displaced from the initial position, and back to the initial position, the final mirror returning to the initial position at the end of the period of time T.

6. The method of clause 3 or 5, wherein the speed of the scanning movement of the substrate is such that during a period of time T the substrate moves a distance which corresponds with the width of an exposure area defined by the patterned radiation beam, and wherein during the period of time T the final mirror moves through one or more cycles of orientations from an initial orientation to a rotated orientation and back to the initial orientation, the final mirror returning to the initial orientation at the end of the period of time T.

7. The method of clause for 2, wherein the position of the substrate is fixed relative to the projection system during exposure of a target portion, the exposure of the target portion taking place over a period of time T, and wherein during the period of time T the final mirror moves through one or more cycles of movement from an initial position, to positions which are displaced from the initial position, and back to the initial position, the final mirror returning to the initial position at the end of the period of time T.

8. The method of clause 2 or 7, wherein the position of the substrate is fixed relative to the projection system during exposure of a target portion, the exposure of the target portion taking place over a period of time T, and wherein during the period of time T the final mirror moves through one or more cycles of orientations from an initial orientation to a rotated orientation and back to the initial orientation, the final mirror returning to the initial orientation at the end of the period of time T.

9. The method of clause 5 or 6, wherein the initial position of the final mirror is at one extreme of a range of positions through which the final mirror passes during a cycle of movement of the final mirror.

10. The method of any of the clauses 1-9, wherein the projection system comprises at least 4 mirrors.

11. The method of clause 10, wherein the projection system comprises 6 mirrors.

12. An EUV lithographic apparatus comprising a projection system having a plurality of mirrors and a substrate table configured to support a substrate, a final mirror of the projection system being arranged to direct a patterned radiation beam onto the substrate, wherein the apparatus further comprises an actuator configured to move the final mirror of the projection system in a direction substantially perpendicular to the surface of the substrate, and configured to rotate the final mirror in a manner which will substantially compensate for unwanted translation of the projected patterned radiation beam on the substrate due to the movement of the mirror.

13. The apparatus of clause 12, wherein the actuator is configured to synchronize the rotation of the final mirror with the movement of the final mirror.

14. The apparatus of clause 12 or 13, wherein the lithographic apparatus is a scanning apparatus arranged to move the substrate relative to the projection system in a scanning movement, and the rotation of the final mirror is around an axis which is substantially perpendicular to the direction of scanning movement of the substrate.

15. The apparatus of any of the clauses 12-14, wherein the actuator is configured such that an initial position of the final mirror is at one extreme of a range of positions through which the final mirror passes during a cycle of movement of the final mirror.

16. The apparatus of any of the clauses 12-15, wherein the projection system comprises at least 4 mirrors.

17. The apparatus of clause 16, wherein the projection system comprises 6 mirrors.

18. The apparatus of any of the clauses 12-17, wherein the actuator is controlled by a control system which comprises high frequency components and low frequency components.

### CONCLUSION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1.-36. (canceled)

37. A method comprising:
using a projection system to project a patterned beam onto a substrate; and
moving a mirror of the projection system in a direction substantially perpendicular to a surface of the substrate,
whereby the rotating of the mirror substantially compensates for unwanted translation of the patterned beam on the substrate due to the movement of the mirror.

38. The method of claim 37, further comprising synchronizing the rotation of the mirror with the movement of the mirror.

39. The method of claim 37, wherein the lithographic apparatus is a scanning apparatus which moves the substrate relative to the projection system in a scanning movement, and the rotation of the final mirror is around an axis that is substantially perpendicular to the direction of scanning movement of the substrate.

40. The method of claim 37, wherein an intensity of radiation at outer portions of an exposure area is greater than an intensity of radiation at other portions of the exposure area.

41. The method of claim 40, wherein:
the speed of the scanning movement of the substrate is such that during a period of time T the substrate moves a distance which corresponds with the width of an exposure area defined by the patterned beam; and
during the period of time T the mirror moves through one or more cycles of movement from an initial position, to positions which are displaced from the initial position, and back to the initial position, the mirror returning to the initial position at the end of the period of time T.

42. The method of claim 40, wherein:
the speed of the scanning movement of the substrate is such that during a period of time T the substrate moves a distance which corresponds with the width of an exposure area defined by the patterned beam; and
during the period of time T the mirror moves through one or more cycles of orientations from an initial orientation to a rotated orientation and back to the initial orientation, the mirror returning to the initial orientation at the end of the period of time T.

43. The method of claim 37, wherein:
the position of the substrate is fixed relative to the projection system during exposure of a target portion;
the exposure of the target portion takes place over a period of time T; and
during the period of time T the mirror moves through one or more cycles of movement from an initial position, to positions which are displaced from the initial position, and back to the initial position, the mirror returning to the initial position at the end of the period of time T.

44. The method of claim 38, wherein:
the position of the substrate is fixed relative to the projection system during exposure of a target portion;
the exposure of the target portion taking place over a period of time T; and
during the period of time T the mirror moves through one or more cycles of orientations from an initial orientation to a rotated orientation and back to the initial orientation, the mirror returning to the initial orientation at the end of the period of time T.

45. The method of claim 41, wherein the initial position of the mirror is at one extreme of a range of positions through which the mirror passes during a cycle of movement of the mirror.

46. The method of claim 37, wherein the projection system comprises at least 4 mirrors.

47. The method of claim 41, wherein the projection system comprises 6 mirrors.

48. An EUV lithographic apparatus comprising:
a projection system having a plurality of mirrors, one being a final mirror;
a substrate table configured to support a substrate; and
an actuator,
wherein a final mirror of the plurality of mirrors is arranged to direct a patterned beam onto the substrate,
wherein the actuator is configured to move the final mirror in a direction substantially perpendicular to the surface of the substrate and to rotate the final mirror in a manner that will substantially compensate for unwanted translation of the patterned radiation beam on the substrate due to the movement of the final mirror.

49. The apparatus of claim 48, wherein the actuator is configured to synchronize the rotation of the final mirror with the movement of the final mirror.

50. The apparatus of claim 48, wherein:
the lithographic apparatus is a scanning apparatus arranged to move the substrate relative to the projection system in a scanning movement; and
the rotation of the final mirror is around an axis which is substantially perpendicular to the direction of scanning movement of the substrate.

51. The apparatus of claim 48, wherein the actuator is configured such that an initial position of the final mirror is at one extreme of a range of positions through which the final mirror passes during a cycle of movement of the final mirror.

52. The apparatus of claim 48, wherein the projection system comprises at least 4 mirrors.

53. The apparatus of claim 48, wherein the projection system comprises 6 mirrors.

54. The apparatus of claim 48, wherein the actuator is controlled by a control system which comprises high frequency components and low frequency components.
